(19) United States
(12) Patent Application Publication
(10) Pub. No.: US 2021/0282461 A1
(43) Pub. Date: Sep. 16, 2021

(54) DEVICE FOR GENERATING AN AEROSOL

(71) Applicant: Philip Morris Products S.A., Neuchatel (CH)

(72) Inventor: Rui Nuno BATISTA, Neuchatel (CH)

(73) Assignee: Philip Morris Products S.A., Neuchatel (CH)

(21) Appl. No.: 17/261,363

(22) PCT Filed: Jul. 24, 2019
(86) PCT No.: PCT/EP2019/069929

§ 371 Date: Jan. 19, 2021

(30) Foreign Application Priority Data
Jul. 26, 2018 (EP) 18185898.6

(51) Int. Cl. A24F 40/465; A24F 40/48

(52) U.S. Cl. CPC A24F 40/465; A24F 40/48

(57) ABSTRACT

A device for generating an aerosol is provided, including: a heating chamber configured to receive an article including an aerosol-forming substrate configured to form the aerosol, the heating chamber including an upstream end, a downstream end, and first and second major boundary surfaces, the first and the second major boundary surfaces extending in facing parallel relations and defining a principal flow axis for fluid flowing through the heating chamber; a cooling chamber in fluid communication with the heating chamber and a mouthpiece end of the device; and one or more induction coils configured to inductively heat the article and each surrounding the heating chamber, the device being configured such that, in use, fluid flow from the upstream end of the heating chamber to the downstream end of the heating chamber is in a direction substantially parallel to the principal flow axis. Methods for generating an aerosol are also provided.

This invention relates generally to a device for generating an aerosol. The invention also relates to a method of using such a device for generating an aerosol.

Devices for generating aerosols which heat rather than combust an aerosol-forming substrate have previously been proposed in the art. For example, heated smoking devices in which tobacco is heated rather than combusted, have been proposed. One aim of such smoking devices is to reduce the generation of undesirable smoke constituents of the type produced by the combustion and pyrolytic degradation of tobacco in conventional cigarettes.

Typically, in heated smoking devices, which heat rather than combust, an aerosol is generated by the transfer of heat from a heat source to a physically separate article for forming an aerosol comprising an aerosol-forming substrate or material. The article may be located within, around or downstream of the heat source. During generation of an aerosol by such smoking devices, volatile compounds are released from the aerosol-forming substrate by heat transferred from the heat source to the aerosol-forming substrate. The volatile compounds are then entrained in air drawn through the smoking device to thereby generate an aerosol as the released compounds cool and condense. This aerosol is then inhaled by a user of the smoking device.

Heated smoking devices of the above-described type commonly comprise a cavity into which an aerosol-forming article is inserted prior to use. The aerosol-forming article contains the aerosol-forming substrate which is subsequently heated to generate the aerosol. In this way, when the aerosol-forming substrate contained in an aerosol-forming article has been exhausted the aerosol-forming article can be replaced, with the heated smoking device thereby constituting a reusable device. The aerosol-forming articles are normally shaped and sized to correspond, broadly, to that of conventional cigarettes. Accordingly, the aerosol-forming articles, and the cavity in the heated smoking device into which it is inserted or insertable, have a generally cylindrical shape. Typically, the diameter of the aerosol-forming article is about 7.2 mm.

Aerosol-forming articles of the above-described type typically have a wrapper or carrier layer within which the aerosol-forming substrate is retained. Filter material is generally provided at one or both of the ends of the aerosol-forming article, serving as a plug to retain the aerosol-forming substrate within the article and, also, to filter aerosol generated by the heated smoking device, in use. Additionally, a cooling segment (commonly comprising a cardboard tube or hollow acetate tube) is located within the aerosol-forming article, between the aerosol-forming substrate and the filter at one end of the article.

In use, a user inserts an aerosol-forming article into the cavity of a heated smoking device and draws on a free end of the aerosol-forming article (said free end comprising filter material). The heat source within the heated smoking device is activated to transfer thermal energy to the aerosol-forming article, thereby releasing volatile compounds from the aerosol-forming substrate. Air is drawn into the heated smoking device by the user drawing on the aerosol-forming article. The air flows through at least part of the device and then into and along the length of the aerosol-forming article, passing through the aerosol-forming substrate and drawing released volatile compounds therefrom it. The air flow and volatile compound mixture then passes through the cooling segment, where the volatile compounds cool and condense into an aerosol. This aerosol then passes through the filter material before being drawn into the lungs of the user. The wrapper or carrier layer acts as a baffle during this process and serves to direct the air flow causing it to flow through and along the aerosol-forming article to the user.

Heating an aerosol-forming substrate, rather than combusting it, requires that the aerosol-forming substrate is heated to a relatively reduced temperature. Accordingly, a relatively reduced amount of thermal energy need be transferred to the aerosol-forming substrate. The energy saved beneficially reduces the expense of operating the heated smoking device. Furthermore, heating rather than combusting the aerosol-forming substrate may result in a more efficient use of the substrate, thereby requiring relatively lower quantities of it, with further consequential cost savings.

It would be desirable to provide a device for generating an aerosol which consumes a yet further reduced quantity of energy during use. It would be desirable to provide a device for generating an aerosol which has an improved efficiency of transferring thermal energy to an article for forming an aerosol received therewithin. It would also be desirable to provide a device for generating an aerosol which facilitates the use of an article for forming an aerosol in a form which is relatively less expensive and/or complex to manufacture, therefore having a reduced cost. It would also be desirable to provide a device for generating an aerosol which facilitates the use of an article for forming an aerosol from which volatized compounds are more readily and/or efficiently released.

There is provided a device for generating an aerosol. The device may comprise a heating chamber for receiving an article for forming an aerosol comprising aerosol-forming substrate. The heating chamber may comprise an upstream end, a downstream end and first and second major boundary surfaces. The first and second major boundary surfaces may extend in facing parallel relations and define a principal flow axis for fluid flowing through the heating chamber. The device may be configured such that fluid flow, in use, from the upstream end to the downstream end of the heating chamber is in a direction substantially parallel to the principal flow axis.

According to the invention, there is provided a device for generating an aerosol, the device comprising a heating chamber for receiving an article for forming an aerosol comprising aerosol-forming substrate and a cooling chamber in fluid communication with the heating chamber and a mouthpiece end of the device, the heating chamber comprising an upstream end, a downstream end and first and second major boundary surfaces, the first and second major boundary surfaces extending in facing parallel relations and defining a principal flow axis for fluid flowing through the heating chamber, where the device is configured such that fluid flow, in use, from the upstream end to the downstream end of the heating chamber is in a direction substantially parallel to the principal flow axis.

Advantageously, provision of a heating chamber having first and second major boundary surfaces extending in facing parallel relations provides for a relatively more efficient transfer of thermal energy into an aerosol-forming substrate of an article for forming an aerosol received within the heating chamber. The phrase ‘facing parallel relations’ refers to the fact that the first and second major boundary surfaces are opposing each other in a substantially parallel manner or are facing each other in a substantially parallel manner. Prior art devices define a generally cylindrical aperture for receipt therein of prior art articles for forming an aerosol comprising from aerosol-forming substrate (which also generally have cylindrical shape, as explained above). Accordingly, the aerosol-forming substrate at the centre region of the articles, as viewed cross-sectionally, is thermally insulated by the aerosol-forming substrate thereabout said central region. Transferring sufficient thermal energy into this central region of prior art aerosol-forming articles in order to heat the substrate to a sufficient temperature for volatilization to occur, therefore, requires relatively increased application of thermal energy than does heating of regions of the aerosol-forming articles nearer to their periphery. Provision of parallel major boundary surfaces in the present invention ensures that thermal energy has a relatively reduced path to travel into an aerosol-forming substrate of an article for forming an aerosol received in the heating chamber, for a given volume of substrate. Moreover, such an arrangement of major boundary surfaces provides a relatively increased surface area to volume ratio (vis-à-vis prior art articles for forming an aerosol), thereby enabling more efficient thermal transfer to the aerosol-forming substrate.

Advantageously, due to flow from the upstream end to the downstream end of the heating chamber being substantially parallel to the principal flow axis, an article for forming an aerosol received in the heating chamber (e.g. usable with the device) may advantageously be provided with a simpler construction than is typically the case with prior art articles for forming an aerosol.

Further advantageously, provision of a device in which the first and second major boundary surfaces cause the fluid exiting the heating chamber to flow in a direction parallel to the principal flow axis allows the device to have a simple shape, for example extending generally along the principal flow axis. Devices having such simple shapes may beneficially be manufactured from fewer component parts, may therefore be easier to construct, and therefore have a relatively reduced expense (compared to more complex shapes).

As used herein, the phrase ‘aerosol-forming substrate’ is used to describe a substrate capable of releasing upon heating volatile compounds, which can form an aerosol. The aerosol generated from aerosol-forming substrates described herein may be visible or invisible to the human eye. The aerosol-forming substrate may comprise a solid, a fluid or a mixture of solid and fluid substrate. Where the aerosol-forming substrate is a fluid it is advantageously retained within a matrix and/or by a cover layer, at least prior to receipt of the aerosol-forming substrate in the heating chamber.

As used herein, the term ‘and/or’ is used to refer to either one of two stated options or both of two stated options. For example, A and/or B is used to refer to either one of A and B or both A and B. Further, the phrase ‘at least one of A and B’ falls within the definition of ‘A and/or B’.

As used herein, the term ‘aerosol’ is used to describe a suspension of relatively small particles in a fluid medium.

As used herein, the phrase ‘heating chamber’ is used to mean a space within which an article for forming an aerosol comprising an aerosol-forming substrate is received or receivable and is heated or heatable. The first and second major boundary surfaces at least partially define the periphery of the heating chamber.

As used herein, the term ‘major’ in respect of the first and second major boundary surfaces requires that said surfaces each comprise a greater surface area of the heating chamber than do other surfaces of the heating chamber.

As used herein, the phrase ‘principal flow axis’ is used to mean a flow direction which is the primary direction of flow.

As used herein, the phrase ‘upstream end’ is used to mean an end of the heating chamber through which fluid may flow into the heating chamber, in use.

As used herein, the phrase ‘downstream end’ is used to mean the end of the heating chamber through which fluid may flow out of the heating chamber, in use.

According to the invention, there is provided in combination, a device for generating an aerosol and an article for forming an aerosol, the device comprising a heating chamber for receipt therein of the article, the heating chamber comprising first and second major boundary surfaces extending in facing parallel relations, the article comprising an aerosol-forming substrate and being configured (that is, sized and/or shaped) to contact both the first and second major boundary surfaces when it is received within the heating chamber. Such a combination of a device for generating an aerosol and an article for forming aerosol forms a system for generating an aerosol.

In some embodiments, the first and second major boundary surfaces of the device of the combination may define a principal flow axis for fluid flowing through the heating chamber. In some embodiments, the heating chamber may comprise an upstream end and a downstream end. In some embodiments, the device may be configured such that fluid flow, in use, from the upstream end to the downstream end of the heating chamber is in a direction substantially parallel to the principal flow axis.

In some embodiments, the device may be configured such that fluid flows or is flowable, in use, through the upstream end of the heating chamber in a direction substantially parallel to the principal flow axis. In some embodiments, the first and second major boundary surfaces may be arranged (for example when extending in facing parallel relations) to cause fluid exiting the heating chamber to flow in a direction substantially parallel to the principal flow axis.

As used herein, the phrase ‘to cause fluid exiting the heating chamber to flow in a direction’ is intended to mean that fluid flowing through the heating chamber flows in the required direction (i.e. substantially parallel to the principal flow axis) due to the first and second major boundary surfaces.

The device for generating an aerosol may comprise an aerosol generation device. In some embodiments, the device for generating an aerosol may comprise an electrical device. The device for generating an aerosol may comprise a smoking device, for example an electrically heated smoking device. The smoking device (e.g. the electrically heated smoking device) may be for generating an aerosol, for example which may be inhalable by a user.

The device may comprise first and second ends. The device may extend between the first and second ends in a direction which is substantially parallel to the principal flow axis. The first end may comprise a mouthpiece end. The device may comprise a mouthpiece, which may be integrally or non-removably attached to the rest of the device. Alternatively, the device may comprise a mouthpiece which is removably attached or attachable to the rest of the device. Alternatively, the device may be provided without a mouthpiece for example and may comprise a mouthpiece connection for connection to a mouthpiece. The heating chamber may be located at or adjacent the second end of the device. Alternatively, the heating chamber may be located between the first and second ends of the device. The first end may comprise an upstream end of the device. The second end may comprise a downstream end of the device. In use, a user may draw on the first end in order to inhale aerosol generated by the device.

The device may be a portable or handheld device, for example which may be comfortable for a user to hold between the fingers of a single hand.

In some embodiments, the device may comprise a housing, for example within which the heating chamber may be housed. The housing may be formed from any suitable material or combination of materials, for example plastics materials, metals, etc. The device (e.g. the housing) may be substantially flat on one or more of its outer surfaces, for example may have a generally parallelepiped shape. The housing may comprise first and second portions, for example which may be movable relative to one another. The first portion may be attached or attachable to the first major boundary surface. The second portion may be attached or attachable to the second major boundary surface.

In some embodiments, the first major boundary surface is movable relative to the second major boundary surface, for example into an open position or condition in which an article for forming an aerosol comprising an aerosol-forming substrate is insertable or removable from the heating chamber. In some embodiments, the first major boundary surface is slideable relative to the second major boundary surface, for example into the open position or condition. In some embodiments, the first major boundary surface is pivotable relative to the second major boundary surface, for example into the open position or condition.

In some embodiments, the first major boundary surface is retained relative to the second major boundary surface in the open position or condition. For example, the device may comprise retaining means or mechanism for retaining the first major boundary surface in the open position or condition. Where the first major boundary surface is pivotable relative to the second major boundary surface the retaining means or mechanism may comprise one or more hinges, for example which may be arranged or arrangeable to hingedly or pivotably attach the first major boundary surface to the rest of the device. Where the first major boundary surface is slideable relative to the second major boundary surface the retaining means or mechanism may comprise a sliding mechanism. The sliding mechanism may be arranged such that the first major boundary surface is slideable to or toward and/or away from the open position or condition, for example in a direction substantially parallel to the principal flow axis. In some embodiments, the first and second major boundary surfaces may be operably associated with one another, for example to allow insertion and/or removal of an article for forming an aerosol (e.g. into and/or from the heating chamber).

In some embodiments, the device may comprise an aperture or opening for the insertion into and/or removal from the heating chamber of an article for forming an aerosol comprising an aerosol-forming substrate. The aperture or opening may be located at or adjacent the second end (where provided) of the device. The aperture or opening may be located upstream of the heating chamber. The aperture or opening may extend into and/or through the housing of the device (where provided). The aperture and/or opening may extend in a direction substantially parallel with the principal flow axis. Alternatively, the aperture or opening may extend in a direction substantially perpendicular to the principal flow axis. Alternatively, the aperture or opening may extend in a direction at an acute angle to the principal flow axis. The aperture or opening may be configured (e.g. shaped and/or sized) to allow passage therethrough of an article for forming an aerosol, for example such that said article is removable from and/or insertable into the device. The aperture or opening may comprise one or more guide surface, for example configured to facilitate passage of an article for forming an aerosol through the aperture or opening. The or each guide surface may extend in a direction at an acute angle to the principal flow axis. The or each guide surface may be at least partially curved.

In some embodiments, the heating chamber may be configured to enclose an article for forming an aerosol comprising an aerosol-forming substrate received therewithin, for example when the first and second major boundary surfaces are in facing parallel relations. In some embodiments, the first and/or second major boundary surfaces may be substantially flat. The heating chamber may comprise a generally parallelepiped shape.

In some embodiments, the upstream end of the heating chamber may comprise a fluid inlet. The downstream end of the heating chamber may comprise a fluid outlet. The fluid outlet may be in fluid communication with the first end (where provided) of the device, for example may be operatively in fluid communication with the first end of the device. The device may comprise one or more air inlets, for example extending through and/or into the housing (where provided) of the device. The one or more air inlets may be in fluid communication with the fluid inlet, e.g. may be operatively in fluid communication with the fluid inlet.

The heating chamber may comprise first and second minor boundary surfaces. The first and second minor boundary surfaces may extend in substantially facing parallel relations to one another, for example and substantially parallel to the principal flow axis. The first and second minor boundary surfaces may extend in a direction substantially perpendicular to a plane defined by the first and/or second major boundary surface(s).

The first and second major boundary surfaces may each have a width and a length. A ‘width’ may be defined as the distance between opposed edges of a surface extending in a direction generally perpendicular to the principal flow axis. A ‘length’ may be defined as the distance between opposed edges of a surface extending in a direction generally parallel to the principal flow axis. In facing parallel relations the first and second major boundary surfaces may be spaced from one another by a distance which is less than any of their lengths and widths, for example they may be spaced from one another by a distance which is less than half of any of their lengths and widths. In some embodiments, the first and/or second major boundary surfaces may have a width of between 5, 6, 7 or 8 mm and 9, 10, 11, 12, 13, 14, 15, 16, 17, 18, 19, 20, 21, 22, 23, 24 or 25 mm. In some embodiments, the first and/or second major boundary surfaces may have a length of between 5, 6, 7 or 8 mm and 9, 10, 11, 12, 13, 14, 15, 16, 17, 18, 19, 20, 21, 22, 23, 24 or 25 mm. The length of the first and/or second major boundary surface may be greater than or the same size as its width. The first and/or second major boundary surfaces may have a substantially constant width along their lengths. Where the width of the first and/or second major boundary surface varies along its or their length(s) the above-described dimensions relate to a mean width.

In some embodiments, when the first and second major boundary surfaces extend in facing parallel relations, the first and second major boundary surfaces are spaced from one another by a distance of less than 5 mm, say less than 4 mm, for example less than 3 mm, e.g. less than 2.5 mm.

In some embodiments, the first and/or second boundary surface may be movable relatively toward and/or away from the other of the first and second boundary surface or toward one another (e.g. in a direction perpendicular to the principal flow axis), for example when an article for forming an aerosol is received therebetween. The first and/or second boundary surface may be movable, in use, to reduce the volume of the heating chamber and/or to contact and/or impinge upon an article for forming an aerosol received therebetween. The device may be configured or configurable to move the first and/or second boundary surface toward the other of the first and second boundary surface or toward and/or away from one another (e.g. in a direction perpendicular to the principal flow axis), for example when an article for forming an aerosol is received therebetween. Movement of the first and/or second boundary surface toward the other of the first and second boundary surface or toward one another may be configured to reduce the volume of an article for forming an aerosol received therebetween, for example to thereby at least partially compress or squeeze the article for forming an aerosol. At least partially compressing or squeezing the article for forming an aerosol may cause or trigger movement of one or more substance within and/or from the article for forming an aerosol. Movement of the first and/or second boundary surface toward the other of the first and second boundary surface or toward one another may be configured to reduce the volume of the article for forming an aerosol, for example to thereby at least partially compress or squeeze the article for forming an aerosol. At least partial compressing or squeezing the article for forming an aerosol may cause or trigger movement of one or more substances within and/or from the article for forming an aerosol (for example at least some aerosol-forming substrate may be moved in such a manner).

The device may be configured or configurable to move the first and/or second boundary surface toward the other of the first and second boundary surface or toward one another upon reaching a trigger event. The trigger event may comprise one or more of: a number of puffs taken on the device (for example which may be monitored, say by a sensor); a pre-set time interval after a first puff (or after any particular number of puffs); a temperature of one or each of the major boundary surfaces and/or the heating chamber and/or an article for forming an aerosol received therein reaching a pre-set temperature (where the temperature inside the device 1 and/or the article may be monitored by a sensor, directly or indirectly).

The device may comprise movement means or mechanism arranged to move the first and/or second boundary surface toward and/or away from the other of the first and second boundary surface or toward and/or away from one another. The movement means or mechanism may comprise gearing, a ratchet, or the like.

In some embodiments, the device may comprise a retention means or mechanism for retaining (e.g. releasably) an article for forming an aerosol in the heating chamber. The retention means or mechanism may comprise one or more abutments, for example which may be fixed or may be movable relative to the heating chamber. Where the one or more abutments are movable relative to the heating chamber, one, some or each abutment may be resiliently biased toward or away from a retention position in which an article for forming an aerosol is retained or retainable within the heating chamber. The retention means may comprise one or more catch, clamp or clip, for example which may be configured to grip and engage an article for forming an aerosol and thereby retain it in the heating chamber.

The device may comprise a carrousel or carriage, for example for holding and/or guiding an article for forming an aerosol. The device may be configured to enable and/or support sliding of the carrousel or carriage into and/or out of the heating chamber. The retention means or mechanism may be configured to releasably retain the carrousel or carriage, for example such that an article for forming an aerosol held therein or thereon is at least partially received within the heating chamber.

In some embodiments, the device may comprise engagement means or mechanism for engaging and/or moving an article for forming an aerosol into and/or out of the heating chamber. The device may comprise a housing, for example and the housing may comprise the engagement means or mechanism. The engagement means or mechanism may comprise an extension portion of the housing. The extension portion may extend outboard of the first major boundary surface, for example in a direction generally parallel thereto. The extension portion (for example at least a part thereof) may be deformable (e.g. resiliently) or movable (e.g. resiliently), for example in a direction perpendicular to a plane defined by the first major boundary surface. The extension portion may comprise a free end. The free end may be tapered or curved or bevelled.

The extension portion may be provided with surface effects configured to enhance the coefficient of friction of its surface. For example, the extension portion may be provided with embossments and/or projections, which may define or be arranged in a pattern. Additionally or alternatively, the extension portion may be formed from and/or coated with a material having a relatively high coefficient of friction.

In use, a user of the device may partially depress or deform the extension portion toward the second major boundary surface. An article for forming an aerosol located adjacent the extension portion may thereby be engaged and/or gripped by the extension portion. The user may then move (e.g. slide) the first major boundary surface relative to the second major boundary surface and thereby move the article for forming an aerosol into and/or out of the heating chamber.

The engagement means or mechanism may comprise an abutment member or element. The abutment member or element may be movable relative to the first and/or second major boundary surfaces, for example may be movable at least partially into and/or through the heating chamber. The abutment member or element may be configured to pull or push or drive an article for forming an aerosol out of the heating chamber.

The abutment member or element may be releasably coupleable to the first boundary surface. For example, the abutment member or element may be releasably coupleable to the extension portion of the housing (where provided). The engagement means or mechanism may comprise a coupling mechanism for releasably coupling the abutment member or element to the first major boundary surface or to the extension portion of the housing. The coupling mechanism may comprise an engagement member and a cooperating recess. The abutment member or element may comprise one of the engagement member and recess whilst the extension portion may comprise the other of the engagement member and recess. The engagement member may be resiliently biased toward engagement with and/or into the recess.

In some embodiments, the device may comprise a flavour releasing means or mechanism for selectively releasing a further or additional flavour from an article for forming an aerosol received in the heating chamber. The flavour releasing means or mechanism may comprise a clamping element, for example which is operable to relatively reduce a dimension (e.g. a thickness) of at least a portion of an article for forming an aerosol received in the heating chamber. The flavour releasing means or mechanism may be located adjacent (e.g. directly adjacent) and outboard of the heating chamber. The flavour releasing means or mechanism may be manually operable, for example by a user of the device. The flavour releasing means or mechanism may be biased (e.g. resiliently) toward or away from a condition or position in which engages or is engagable with an article for forming an aerosol received in the heating chamber. The flavour releasing means or mechanism may comprise a resilient biasing member, for example a spring. The flavour releasing means or mechanism (or at least a portion thereof) may be movable relative to the heating chamber in a direction substantially perpendicular to the principal flow axis.

The device may comprise a flavour-generation chamber, for example which may be located adjacent (e.g. directly adjacent) the heating chamber. The flavour-generation chamber may be in fluid communication with the heating chamber. At least a portion of the flavour releasing means or mechanism may be movable, in use, into and/or out of the flavour-generation chamber. The clamping element may comprise a button. The flavour releasing means or mechanism may comprise a clamping surface, for example for engaging a portion of an article for forming an aerosol extending and/or protruding beyond or out of the heating chamber (for example an extension part of the article for forming an aerosol).

The flavour releasing means or mechanism may be configured or configurable to release a flavour from a volatile flavour-generating component of the article for forming an aerosol. The flavour releasing means or mechanism may be configured or configurable to apply a force to, change a temperature of, and/or apply or release a chemical to a volatile flavour-generating component, or any combination thereof. The flavour releasing means or mechanism may be configured or configurable to at least partially crush or deform a capsule located in or on an article for forming an aerosol, for example located in or on an extension part of an article for forming an aerosol.

The flavour releasing means may comprise part of the housing (for example a part of the first portion of the housing and/or the extension portion of the first portion of the housing, where provided). The flavour releasing means may comprise a part of the housing configured to be deformable relative to an adjacent part of the housing. The flavour releasing mechanism may comprise a clamping member and a clamping aperture through the housing. The clamping member may comprise the clamping surface, where provided. The clamping member and/or the clamping aperture may comprise retention means or mechanism, for example configured to retain the clamping member relative to and/or within the clamping aperture and/or the device. The retention means or mechanism may comprise one or more projections (e.g. annular projections) extending from the clamping member and/or the clamping aperture. The clamping member may comprise a button.

In some embodiments, the device may comprise a heater, e.g. for heating the first and/or second major boundary surfaces (e.g. which may thereby comprise heating surfaces). For the avoidance of doubt, where a ‘heater’ is described this may mean one or more heaters. The heater may comprise a resistance heater and/or an induction heater. Where the heater comprises a resistance heater the first and/or second major boundary surface may comprise a heating element, for example a heating coil or blade.

The first and/or second major boundary surface may comprise one or more projections, for example a pattern of projections. The projection(s) (e.g. the pattern of projections) may be configured to relatively increase the working surface area of the first and/or second major boundary surface. Accordingly, thermal transfer between the first and/or second major boundary surface and an article for forming an aerosol received in the heating chamber may be relatively enhanced. In some embodiments the first and/or second major boundary surface may comprise a corrugation, for example comprising substantially parallel peaks and troughs. In some embodiments the peaks and troughs may extend in a direction substantially parallel to the principal flow axis. In some embodiments, at least a portion of the first and/or second major boundary surface may be at least partially resilient, e.g. may be formed from a resilient material and/or may be resiliently biased or supported.

Where the heater comprises an induction heater the heater may comprise one or more induction coils which each surround the heating chamber, e.g. extend around the first and second major boundary surfaces. The longitudinal axis of the or each induction coil may be substantially parallel to the principal flow axis.

As used herein, the term “longitudinal axis” in respect of an induction coil refers to an axis extending through the centre of the coil in a direction generally perpendicular to the turns of the coil.

The device may comprise an induction heater arranged to inductively heat a susceptor of an article for forming an aerosol received within the heating chamber. The induction heater may comprise one or more induction coils located adjacent the first and/or second major boundary surface. The longitudinal axis of the or each induction coil may be substantially perpendicular to the principal flow axis, for example and to a plane defined by the first major boundary surface. In use, a susceptor of an article for forming an aerosol may be inductively heated by the or each induction coil. The susceptor then, in turn, conductively, convectively and/or radiatively heats the aerosol-forming substrate thereabout it.

A ‘susceptor’ refers to an element that heats up when subjected to a varying or alternating magnetic field. Usually, a susceptor is conductive, and heating of the susceptor is the result of eddy currents being induced in the susceptor or hysteresis losses. Both hysteresis losses and eddy currents can occur in a susceptor. A susceptor may include graphite, molybdenum, silicon carbide, stainless steels, niobium, aluminium and any other conductive elements. Preferably, the susceptor element is a ferrite element. The material and the geometry for the susceptor may be chosen to provide a desired electrical resistance and heat generation.

In the operation of an induction heater, a high frequency alternating current is passed through one or more induction coils to generate one or more corresponding alternating magnetic fields that induce a voltage in a susceptor of an article. The induced voltage causes a current to flow in the susceptor and this current causes Joule heating of the susceptor that in turn heats the aerosol-forming substrate. If the susceptor is ferromagnetic, hysteresis losses in the susceptor may also generate heat.

The term ‘high frequency’ denotes a frequency ranging from about 500 Kilohertz (KHz) to about 30 Megahertz (MHz) (including the range of 500 KHz to 30 MHz), in particular from about 1 Megahertz (MHz) to about 10 MHz (including the range of 1 MHz to 10 MHz), and even more particularly from about 5 Megahertz (MHz) to about 7 Megahertz (MHz) (including the range of 5 MHz to 7 MHz).

Throughout the present disclosure, the term ‘magnetic field’ may refer to a varying or alternating magnetic field.

Throughout the present disclosure, the term ‘current’ may refer to an alternating current.

In some embodiments, where the first major boundary surface is movable relative to the second major boundary surface, the heater may comprise contacts configured to be engaged when the first and second major boundary surfaces are in facing parallel relations, for example and to be disengaged when the first major boundary surface is in an open position or condition relative to the second major boundary surface.

The heater may be configured or configurable to heat an article for forming an aerosol received in the heating chamber to a temperature less than 400 degrees centigrade, for example less than 300 degrees centigrade, say less than 270 degrees centigrade. In some embodiments, the heater may be configured or configurable to heat an article for forming an aerosol received in the heating chamber to a temperature less than 250, 225, 200, 175 or 150 degrees centigrade, for example less than 140, 130, 120, 110, 100 or 90 degrees centigrade.

The heater may comprise plural heaters (that is, a plurality of heaters). For example, the heater may comprise one or more resistance heaters and/or one or more induction heaters. Where the heater comprises plural heaters, one or more heaters may be activated or activatable at a different time to one or more of the other heaters. Additionally or alternatively, one or more heaters may be arranged to heat a first portion of the first and/or second major boundary surface whilst one or more of the other heaters may be arranged to heat a second, different portion of the first and/or second boundary surface. Additionally or alternatively, one or more heaters may be arranged to inductively heat a susceptor in a first zone of an article for forming an aerosol received in the heating chamber whilst one or more other heaters may be arranged to inductively heat a susceptor in a second, different zone of the article for forming an aerosol received in the heating chamber. Additionally or alternatively, one or more heaters may be arranged to heat a first zone of the heating chamber whilst another heater may be arranged to heat a second, different, zone of the heating chamber. Additionally or alternatively, one or more heaters may be configured or configurable to heat to a first temperature whilst another heater may be configured or configurable to heat to a second temperature, for example where the second temperature is greater than the first temperature.

In some embodiments, the device may comprise a power source, for example a source of electrical power. The power source may be operably connected or connectable to the heater (where provided). The power source may comprise a battery and/or a capacitor and/or a super capacitor. In some embodiments, the power source may comprise a reservoir of fuel which may be activatable, in use, to heat the heater. The reservoir of fuel may comprise a fluid or solid fuel. Where the fuel is in fluid form the fuel may be deliverable to the heater, in use. For example, the reservoir of fuel may be operably in fluid communication with the heater.

In some embodiments, the device may comprise a control means or mechanism, for example configured or configurable to control operation of the device. The control means or mechanism may comprise electrical circuitry, for example on a printed circuit board. The control means or mechanism may be configured or configurable to control supply of power (e.g. fuel) from a power source, where provided, to the heater, in use. The control means or mechanism may be programmed or programmable to control the thermal energy supplied by the heater to an article for forming an aerosol received in the heating chamber. For example, the control means or mechanism may be programmed or programmable to control the duration of power (e.g. fuel) supplied to the heater and/or to control the amount of power (e.g. fuel) supplied to the heater over a given time interval.

In some embodiments, the device may comprise a trigger means or mechanism for activating the device, for example for activating the generation of aerosol by the device. The trigger means or mechanism may comprise a manually operated or operable actuator or activator, for example a switch or button. Additionally or alternatively, the trigger means or mechanism may comprise an automatically operated or operable actuator or activator, for example a switch actuated by a threshold pressure or flow rate of fluid. In some embodiments, the device may comprise a check or one-way valve configured or configurable to restrict flow through or within the device to a single direction, for example configured or configurable to allow inhalation through the device and to prevent exhalation through the device. Inhalation through the device may comprise flow of fluid (e.g. air) toward the first end, where provided. Exhalation through the device may comprise flow of fluid (e.g. air) toward the second end, where provided.

The resistance to draw (RTD) of the device for generating an aerosol with an article for forming an aerosol received in the heating chamber may be between approximately 80 mmWG and approximately 140 mmWG. As used herein, resistance to draw is expressed with the units of pressure ‘mmWG’ or ‘mm of water gauge’ and is measured in accordance with ISO 6565:2002.

The device may comprise a cooling chamber, for example in fluid communication with the heating chamber. The cooling chamber may be in fluid communication with the mouthpiece or mouthpiece end of the device (where provided). The cooling chamber may be configured or configurable to cool a mixture of fluid and volatilized compounds flowing thereinto. The cooling chamber may have a relatively greater cross-sectional area (e.g. perpendicular to a direction of flow into the cooling chamber) than the cross-sectional area of the heating chamber (e.g. perpendicular to the principal flow axis).

According to the invention, there is provided a system for generating an aerosol, the system comprising a device as described herein and an article for forming an aerosol.

In some embodiments, the article for forming an aerosol may be shaped to closely conform to the heating chamber, for example to the shape and/or dimensions of the heating chamber. Additionally or alternatively, the article for forming an aerosol may comprise one or more extension parts configured (e.g. dimensioned and/or shaped) to extend from the heating chamber, when received therewithin. The extension part(s) may be attached or connected to a main part of the article for forming an aerosol. The extension part(s) may extend from a side, edge or end of the article for forming an aerosol. The article for forming an aerosol may be generally parallelepiped in shape. The article for forming an aerosol may have a width, a length and a thickness. The thickness may be less than both the width and the length. The article may have a first major surface which is substantially flat. The article may have a second major surface which is substantially flat. The first and second major surfaces may be substantially parallel to one another, for example may extend in generally parallel relations. The article may comprise an upstream end. The article may comprise a downstream end. The article may be configured or arranged such that, when it is inserted into the heating chamber of a device for forming an aerosol, fluid is flowable through the article (for example from the upstream end to the downstream end).

Preferably, the aerosol-forming substrate comprises nicotine. The aerosol-forming substrate may comprise tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate.

If the aerosol-forming substrate is in the form of a fluid, for example a liquid or a gas, the aerosol-forming substrate may contain tobacco or non-tobacco volatile flavour compounds, which are released upon heating of the fluid aerosol-forming substrate.

Optionally, the solid or fluid aerosol-forming substrate may be provided on or embedded in a thermally stable carrier. The carrier may take the form of powder, granules, pellets, shreds, strands, strips or sheets. The solid or fluid aerosol-forming substrate may be deposited throughout the carrier, e.g. throughout the volume thereof. Alternatively, the solid or fluid aerosol-forming substrate may be deposited on the surface of the carrier in the form of, for example, a sheet, foam, gel or slurry. The solid or fluid aerosol-forming substrate may be deposited on the entire surface of the carrier, or alternatively, may be deposited in a pattern in order to provide a non-uniform flavour delivery during use.

The article for forming an aerosol may comprise a volatile flavour-generating component. Where provided, the or each extension part of the aerosol-forming substrate may comprise a volatile flavour-generating component.

As used herein the term ‘volatile flavour-generating component’ is used to describe any volatile component that is added to an aerosol-forming substrate in order to provide a flavourant.

The volatile flavour-generating component may be in the form of a liquid or a solid. The volatile flavour-generating compound may be coupled to, or otherwise associated with, a support element. The support element may comprise any suitable substrate or support for locating, holding, or retaining the flavour-generating component. For example, the support element may comprise a fibrous support element, which may be saturated or saturatable with fluid, for example a liquid.

In some embodiments, the volatile flavour-generating component may have any suitable structure in which a structural material releasably encloses a flavourant or flavourants. For example, in some preferred embodiments, the volatile flavour-generating component comprises a matrix structure defining a plurality of domains, the flavourant being trapped within the domains until released, for example, when the aerosol-forming substrate is subject to external force. Alternatively, the volatile flavour-generating component may comprise a capsule. Preferably, the capsule comprises an outer shell and an inner core containing the flavourant. Preferably, the outer shell is sealed before the application of an external force, but is frangible or breakable to allow the flavourant to be released when the external force is applied. The capsule may be formed in a variety of physical formations including, but not limited to, a single-part capsule, a multi-part capsule, a single-walled capsule, a multi-walled capsule, a large capsule, and a small capsule.

If the volatile flavour-generating component comprises a matrix structure defining a plurality of domains enclosing the flavourant, the flavourant delivery member may release the flavourant steadily when the aerosol-forming substrate is subject to external force. Alternatively, if the volatile flavour-generating component is a capsule arranged to rupture or burst to release the flavourant when the article for forming an aerosol is subject to external force (for example, but not limited to, if the capsule comprises an outer shell and an inner core), the capsule may have any desired burst strength. The burst strength is the force (exerted on the capsule from the outside of the aerosol-forming substrate) at which the capsule will burst. The burst strength may be a peak in the capsule's force versus compression curve.

The volatile flavour-generating component may be configured to release the flavourant in response to an activation mechanism. Such an activation mechanism may include the application of a force to the filter, a change in temperature in the filter, a chemical reaction, or any combination thereof.

Suitable flavourants include, but are not limited to, materials that contain natural or synthetic menthol, peppermint, spearmint, coffee, tea, spices (such as cinnamon, clove and ginger), cocoa, vanilla, fruit flavours, chocolate, eucalyptus, geranium, eugenol, agave, juniper, anethole and linalool.

As used herein, the term ‘menthol’ is used to describe the compound 2-isopropyl-5-methylcyclohexanol in any of its isomeric forms.

Menthol may be used in solid or liquid form. In solid form, menthol may be provided as particles or granules. The term ‘solid menthol particles’ may be used to describe any granular or particulate solid material comprising at least approximately 80% menthol by weight.

Preferably, 1.5 mg or more of the volatile flavour-generating component is included in the aerosol-forming substrate.

Preferably, the aerosol-forming substrate comprises an aerosol former.

As used herein, the term ‘aerosol former’ is used to describe any suitable known compound or mixture of compounds that, in use, facilitates formation of an aerosol and that is substantially resistant to thermal degradation at the operating temperature of the aerosol-forming substrate. Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate

Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

Preferably, the aerosol-forming substrate has an aerosol former content of greater than 5% on a dry weight basis.

The aerosol aerosol-forming substrate may have an aerosol former content of between approximately 5% and approximately 30% on a dry weight basis.

In a preferred embodiment, the aerosol-forming substrate has an aerosol former content of approximately 20% on a dry weight basis.

According to the invention, there is provided a method of using a device for generating an aerosol as described herein.

According to the invention, there is provided a method of generating an aerosol, the method comprising:

providing a device for generating an aerosol, the device comprising a heating chamber for receiving an article for forming an aerosol, the heating chamber comprising an upstream end, a downstream end and first and second major boundary surfaces extending in facing parallel relations; and

causing a fluid to flow from the upstream end to the downstream end of the heating chamber in a direction substantially parallel to a principal flow axis defined by the first and second major boundary surfaces.

The method may comprise inserting an article for forming an aerosol (e.g. comprising an aerosol-forming substrate) into the heating chamber. The device may comprise a cooling chamber in fluid communication with the heating chamber and a mouthpiece end of the device.

According to the invention, there is provided a method of generating an aerosol, the method comprising:

providing a device for generating an aerosol, the device comprising a heating chamber for receiving an article for forming an aerosol, the heating chamber comprising first and second major boundary surfaces extending in facing parallel relations;

providing an article for forming an aerosol, the article comprising aerosol-forming substrate; and

inserting the article into the heating chamber of device such that the article contacts both the first and second major boundary surfaces.

The method may comprise heating the article within the heating chamber of the device, for example to generate an aerosol (or a vapour). Where a vapour is generated, the method may comprise cooling the vapour or allowing the vapour to cool, for example to condense the vapour into an aerosol. The device may comprise a cooling chamber in fluid communication with the heating chamber and a mouthpiece end of the device.

All scientific and technical terms used herein have meanings commonly used in the art unless otherwise specified. The definitions provided herein are to facilitate understanding of certain terms used frequently herein.

Throughout the description and claims of this specification, the words “comprise” and “comprising” and variations of them mean “including but not limited to”, and they are not intended to (and do not) exclude other moieties, additives, components, integers or steps. Throughout the description and claims of this specification, the singular encompasses the plural, and vice versa, unless the context otherwise requires. In particular, where the indefinite article is used, the specification is to be understood as contemplating plurality as well as singularity, unless the context requires otherwise.

For the avoidance of doubt, any of the features described herein apply equally to any aspect of the invention. Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one aspect or embodiment of the invention are applicable to all aspects or embodiments, unless such features are incompatible.

The invention will now be further described, by way of example only, with reference to the accompanying drawings, in which:

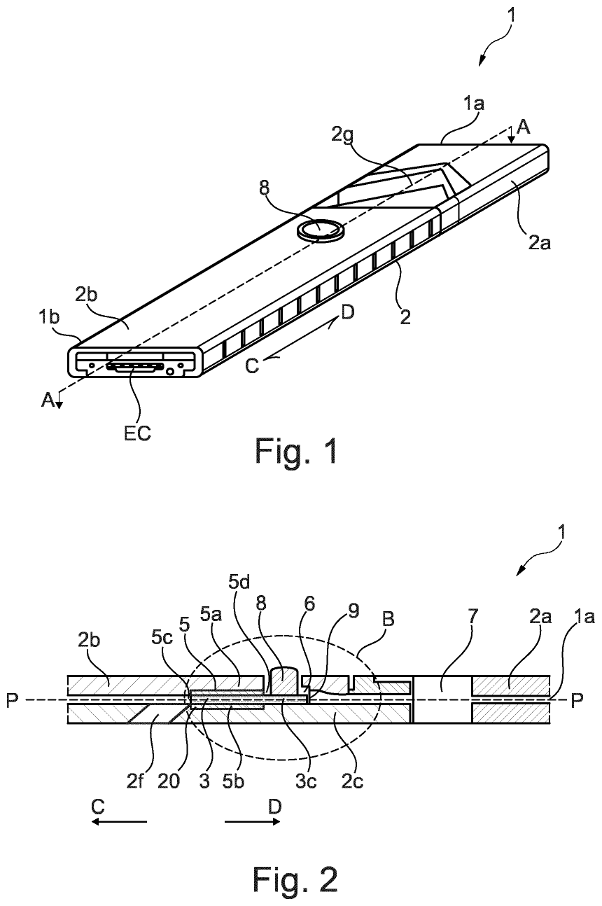

FIG. 1 is a schematic perspective view of a device for generating an aerosol according to an embodiment of the invention;

FIG. 2 is a partial cross-sectional view along plane A-A defined in FIG. 1;

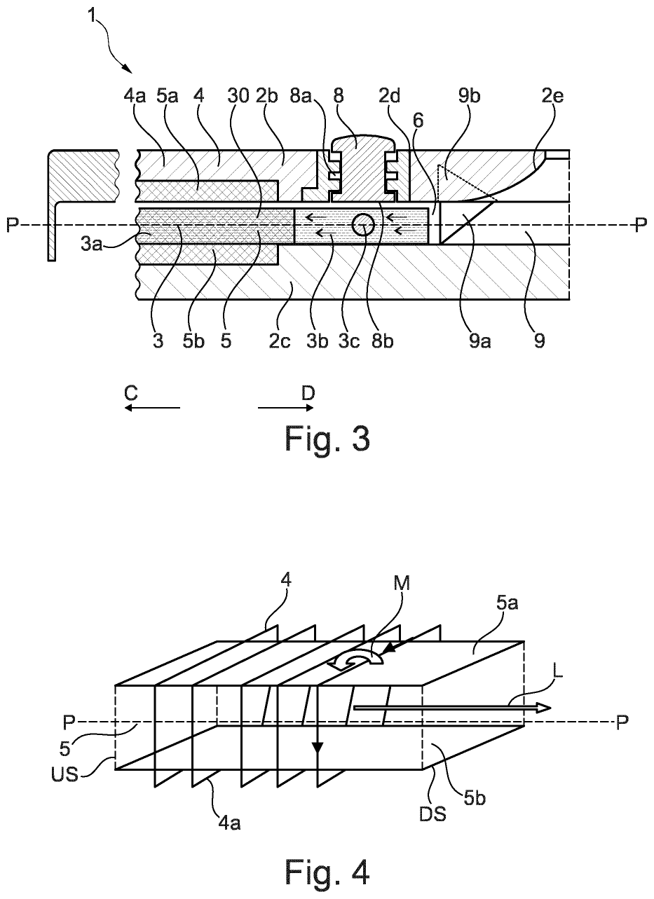

FIG. 3 is a close-up cross-sectional view of portion B from FIG. 2;

FIG. 4 is a schematic perspective view of a heating arrangement for use in a device for generating an aerosol according to an embodiment of the invention; and

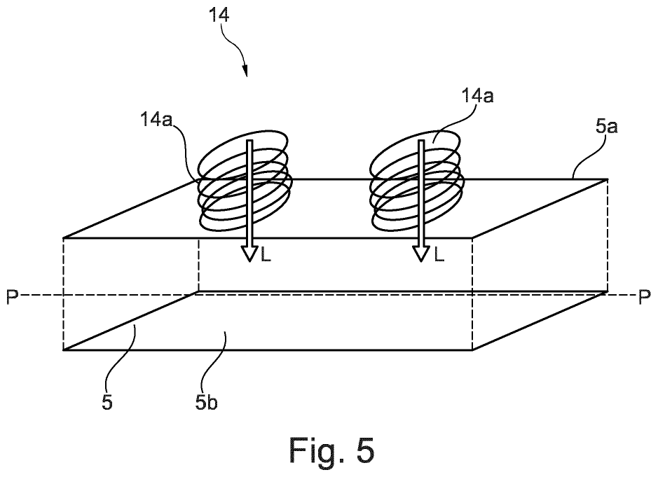

FIG. 5 is a schematic perspective view of an alternative heating arrangement for use in a device for generating an aerosol according to an embodiment of the invention.

Referring now to FIGS. 1, 2 and 3, there is shown a device 1 for generating an aerosol, the device 1 comprising a first, mouthpiece end 1a, and a second, distal end 1b with a housing 2 extending therebetween. The device 1 has a generally parallelepiped shape, in this embodiment. The housing 2 is formed from a plastics material, in this embodiment, and may be moulded into the requisite shape, according to moulding techniques known in the art. In some embodiments, however, the housing 2 may have any suitable shape and may be formed from any suitable material and/or combination of materials.

The mouthpiece end 1a (which provides a downstream end) of the housing 2 comprises a mouthpiece 2a which is removably attached to the remainder of the housing 2 by push-fit. In some embodiments, however, the mouthpiece 2a may be integrally formed with the remainder of the housing 2.

The distal end 1b of the device 1 includes electrical connections EC for programming a control unit (not shown) within the housing 2, for receiving data from a memory (not shown) within the housing 2 and/or for charging a power source (not shown) within the housing 2. The electrical connections EC may comprise one or more of a micro USB, USB-C or a bespoke connection. The distal end 1b of the device 1 may also comprise an alert mechanism (not shown), for example an audio device such as a speaker and/or a light source such as a light emitting diode (LED). The alert mechanism may be configured or configurable to alert a user of the device 1 to a change in the status of the device 1, for example that the power source requires charging.

An article 3 for forming an aerosol comprising aerosol-forming substrate 30 is shown in FIGS. 2 and 3, located in the device 1. However, as will be appreciated by one skilled in the art, the article 3 is separate from, and does not constitute part of, the device 1.

As best shown in FIGS. 2 and 3, the device 1 also comprises a heater 4, a heating chamber 5, an optional flavour-generation chamber 6 and a cooling chamber 7 located within the housing 2, between the mouthpiece and distal ends 1a, 1b of the device 1. The heating chamber 5 is directly adjacent to and in fluid communication with the optional flavour-generation chamber 6. The optional flavour-generation chamber 6 is in fluid communication with the cooling chamber 7, which is in turn in fluid communication with the mouthpiece end 1b of the device 1. A button 8 is located adjacent the optional flavour-generation chamber 6.

The heating chamber 5 comprises first and second major boundary surfaces 5a, 5b. Further, minor, boundary surfaces (not shown) extend between the first and second major boundary surfaces 5a, 5b. The first and second major boundary surfaces 5a, 5b are substantially flat and are formed from metal, for example from iron or an alloy thereof. The heating chamber 5 has a generally parallelepiped shape. As shown in FIGS. 2 and 3, the device 1 is in a first, closed condition, in which the first and second major boundary surfaces 5a, 5b are in facing parallel relations. The first and second major boundary surfaces 5a, 5b define a principal flow axis P, from an upstream end US to a downstream end DS, for fluid flowing through the article 3 received therebetween. An inlet 5c is disposed at one end (the upstream end US) of the heating chamber 5, in fluid communication with the exterior of the housing 2. An outlet 5d is disposed at the opposed end (the downstream end DS) of the heating chamber 5. The principal flow axis P extends between, and is parallel to a flow path between, the inlet 5c and the outlet 5d (e.g. the upstream and downstream ends US, DS).

The heater 4 comprises an induction coil 4a which extends about the periphery of the heating chamber 5. The induction coil 4a is arranged to inductively heat, in use, the first and second major boundary surfaces 5a, 5b. The induction coil 4a is embedded in the housing 2 in this embodiment, however in some embodiments the induction coil 4a may be located within a chamber of the housing 2, instead. As shown more clearly in FIG. 4, the longitudinal axis L of the induction coil 4a is parallel to the principal flow axis P, such that the magnetic field M thereby generated (in use) is perpendicular to the principal flow axis P. The heater 4 is operatively connected or connectable to the power source.

The first major boundary surface 5a is attached to a first portion 2b of the housing 2, while the second major boundary surface 5b is attached to a second portion 2c of the housing 2. The first portion 2b of the housing 2, and hence the first major boundary surface 5a, is slidable relative to the second portion 2c of the housing 2 and the second major boundary surface 5b in a direction parallel to the principal flow axis P. Electric contacts (not shown) in the first portion 2b of the housing 2 are configured to contact electric contacts (not shown) in the second portion 2c of the housing 2 when the first and second major boundary surfaces 5a, 5b are in facing parallel relations (the first, closed condition) as shown in FIGS. 2 and 3. Accordingly, when the device 1 is in the first, closed condition, each of the turns of the induction coil 4a are individually, electrically connected to themselves.

The first and second major boundary surfaces 5a, 5b may comprise corrugations having parallel peaks and troughs (not shown), in this embodiment. The peaks and troughs extend in a direction which is parallel to the principal flow axis P.

The first portion 2b of the housing 2 comprises an extension portion 2d, which extends outboard of the first major boundary surface 5a in a direction generally parallel thereto. The extension portion 2d is resiliently deformable in a direction perpendicular to a plane defined by the first major boundary surface 5a. The free end 2e of the extension portion 2d is tapered.

A removal aperture 2f extends through the second portion 2c of the housing 2, at a location upstream of the heating chamber 5. The removal aperture 2f is shaped and sized to allow, in use, a used article 3 to be removed from the device 1 therethrough. The removal aperture 2f is connected to the heating chamber 5 by a removal passageway 20. Guide surfaces of the removal aperture 2f are arranged to facilitate, in use, sliding removal of a used article 3 from the device 1. The guide surfaces extend in a direction at an acute angle to the principal flow axis P of the heating chamber 5. The guide surfaces are curved, in this embodiment. The removal aperture 2f may comprise an air inlet into the device 1. In some embodiments, the device 1 may comprise one or more additional or alternative air inlets extending through the housing 2 and fluidly communicating with the heating chamber 5.

The mouthpiece 2a comprises a transparent portion 2g in this embodiment (as shown in FIG. 1), through which aerosol generation can be viewed, during use of the device 1.

An abutment element 9 is movable within the device 1, relative to the housing 2, into and or out of the heating chamber 5. The abutment element 9 is configured to pull the article 3 out of the heating chamber 5. The abutment element 9 is located within a slot within the device 1, adjacent and coaligned with the optional flavour-generation chamber 6 and the heating chamber 5. The abutment element 9 and the extension portion 2d of the first portion 2b of the housing 2 comprise a coupling mechanism for releasably coupling the two components together. The coupling mechanism comprises an engagement member or catch 9a and a cooperating recess 9b. In the embodiment shown in FIGS. 2 and 3 the extension portion 2d comprises the recess 9b and the abutment element 9 comprises the engagement member or catch 9a. However, in some embodiments, the extension portion 2d may comprise the engagement member or catch 9a and the abutment element 9 may comprise the recess 9b. The engagement member or catch 9a is resiliently biased (for example by a spring) toward a position in which it engages with and into the recess 9b, thereby coupling the extension portion 2d and the abutment element 9 to one another.

The button 8 comprises a flavour releasing mechanism. The button 8 is disposed in a button aperture 8a which is located adjacent the optional flavour-generation chamber 6 and extends through the extension portion 2d of the first portion 2b of the housing 2. The button 8 is movable, in use, into and out of the optional flavour-generation chamber 6. The button 8 comprises a clamping surface 8b which is arranged to be movable, in use, against an article 3 located in the optional flavour-generation chamber 6. The button 8 comprises annular projections at or adjacent its ends. The button aperture 8b comprise first and second internal abutments, sized and located to engage with the annular projections of the button 8 to thereby retain the button 8 within the button aperture 8b whilst also allowing movement of the button 8 into and out of the optional flavour-generation chamber 6.

The cooling chamber 7 has a greater cross-sectional area (e.g. a greater height and/or width) perpendicular to a flow direction into the cooling chamber 7 than does the fluid flow passageway which fluidly connects the optional flavour-generation chamber 6 to the cooling chamber 7. The cooling chamber 7 also has a greater cross-sectional area (e.g. a greater height and/or width) perpendicular to a flow direction into the cooling chamber 7 than does the fluid flow passageway fluidly connecting the cooling chamber 7 to the mouthpiece end 1a of the device 1.

The article 3 comprises a main part 3a and an optional extension part 3b extending therefrom. The main part 3a is sized and shaped to closely conform to the size and shape of the heating chamber 5 when disposed therewithin. The main part 3a comprises aerosol-forming substrate 30 in the form of a matrix material within which a liquid aerosol-forming substrate 30 is retained, in this embodiment. The optional extension part 3b comprises a holder material within which a volatile flavour-generating component in the form of a capsule 3c is retained. The capsule 3c contains a flavourant, which is methanol in this embodiment.

In use, a user of the device 1 slides the first portion 2b of the housing 2 relative to the second portion 2c of the housing 2 in the direction of arrow C, moving the heating chamber 5 into an open condition. An article 3 is then placed into the interior of the open device 1. The first portion 2b of the housing 2 is then slid relative to the second portion 2c of the housing 2 in the direction of arrow D (i.e. the opposite direction to that designated by arrow C), until the free end 2e of the extension portion 2d of the housing 2 is located above (relatively) the aerosol-forming substrate 30. The user then applies a perpendicular force against the extension portion 2d to resiliently press the tapered free end 2e of the extension portion 2d against the article 3. The user then continues to slide the first portion 2b of the housing 2 relative to the second portion 2c of the housing 2 in the direction of arrow C. The article 3 is thereby engaged by and moved therealong with and by the free end 2e of the extension portion 2d. In this way, the article 3 is moved into the heating chamber 5. The first portion 2b of the housing 2 is slid in the direction of arrow C until the free end 2e of the extension portion 2d engages against an abutment provided on the second portion 2c of the housing 2, which restricts further sliding in this direction. In this closed condition the first and second major boundary surfaces 5a, 5b of the heating chamber 5 are in parallel facing relations and the article 3 is located in the heating chamber 5 (as shown in FIGS. 2 and 3). The optional extension part 3b of the article 3 extends beyond the heating chamber 5 and into the optional flavour-generation chamber 6. The capsule 3c, within the optional extension part 3b, is disposed in the optional flavour-generation chamber 6 and in alignment with the button 8 when the device 1 is in the closed condition.

In the closed condition, the engagement member or catch 9a is aligned with the recess 9b and is resiliently biased into engagement thereinto. In this way, the abutment element 9 is coupled to the extension portion 2d of the first portion 2b of the housing 2 by the coupling mechanism.

When a user wants to use the device 1, the heater 4 is activated. This activation may be triggered by a trigger mechanism (not shown) such as a flow and/or pressure sensor which may be configured to respond to air flow and/or a change in air pressure resulting from a user drawing on the mouthpiece end 1a of the device 1. In some embodiments, however, the trigger mechanism may comprise a manually activated and/or activatable switch. Electrical power from the power source is supplied to the heater 4 under the control of the control unit. In this way, the temperature of the first and second major boundary surfaces 5a, 5b is increased to a volatilization temperature, which in this embodiment is a temperature less than 270 degrees centigrade. Compounds are volatilized from the aerosol-forming substrate 30 of the article 3 by thermal energy applied from the first and second major boundary surfaces 5a, 5b.

Air is drawn through the device 1 by the user drawing on the mouthpiece end 1a of the device 1. The air flows from the removal aperture 2f, through the inlet 5c of the heating chamber 5, along the principal flow axis P (i.e. parallel thereto) of the heating chamber, and exits the heating chamber 5 through the outlet 5d. The air passes through the article 3 from its upstream end US to its downstream end DS, whereby volatilized compounds are entrained into the flow of air through the heating chamber 5. When the air flow and volatilized compounds mixture reaches the cooling chamber 7 the mixture expands due to the relatively increased cross-sectional area of the cooling chamber 7. The mixture thereby cools in the cooling chamber 7 and the volatilized compounds coalesce into and form an aerosol. The aerosol is then drawn through the mouthpiece 2a and to the user drawing thereupon.

The user can depress the button 8 into the optional flavour-generation chamber 6 to crush the adjacent capsule 3c within the optional extension part 3b of the article 3, thereby releasing flavourants therefrom. Flavourants released from the capsule 3c will then be drawn to the user through an air flow through the device 1 caused by a user drawing on the mouthpiece end 1a of the device 1.

The article 3 is removed from the device 1 when its supply of volatilizable compounds has been exhausted, when a set number of draws has been applied to the device 1, or when the user decides to change the article 3 for any other reason (for example to experience a different flavour). The user slides the first portion 2b of the housing 2 relative to the second portion 2c of the housing 2 in the direction of arrow D, moving the device 1 away from the closed condition and toward the open condition. The abutment element 9 (which is coupled to the extension portion 2d of the first portion 2b of the housing 2 by the coupling mechanism) is dragged by the first portion 2b of the housing 2 to contact and push the article 3 out of the optional flavour-generation chamber 6 and the heating chamber 5. Continued sliding of the first portion 2b of the housing (relative to the second portion 2c of the housing 2) in the direction of arrow D causes the abutment element 9 to push the used article 3 into the removal aperture 2f. The guide surfaces of the removal aperture 2f guide the article 3 to slide out of the device 1, from where it may collected by any suitable means.

Referring now to FIG. 5, there is shown an alternative heater 14 for heating the contents of the heating chamber 5 of device 1. The heater 14 shown in FIG. 5 differs from that shown in FIG. 4 in that there are two induction coils 14a and the induction coils 14a are arranged such that their longitudinal axes L are perpendicular to the principal flow axis P. The induction coils of the heater 14 are arranged to heat, in use, a susceptor of an aerosol-forming substrate 30 received in the heating chamber 5.

Whilst the first portion 2b of the housing 2 is described as being slidable relative to the second portion 2c of the housing 2, this need not be the case and, instead, the first portion 2b may be pivotable relative to the second portion 2c and/or removable therefrom. In some embodiments, the first portion 2b may be fixed relative to the second portion 2c of the housing 2 (such that the first and second major boundary surfaces 5a, 5b of the heating chamber 5 are also fixed relative to one another). Where the first and second portions 2a, 2b are fixed relative to one another the device 1 may comprise a carriage for holding and/or guiding an aerosol-forming substrate into and/or out of the heating chamber 5. The device may be configured to support the carriage in sliding relation thereto.

Whilst both first and second major boundary surfaces 5a, 5b are described as being heated by the heater 4, this need not be the case and, instead, only one of the major boundary surfaces 5a, 5b may be heated.

In some embodiments, the device 1 may comprise plural heaters, which may comprise both a heater configured or arranged to heat the first and/or second major boundary surfaces 5a, 5b (for example of the type of heater 4 shown in FIG. 4) and a heater configured to heat the susceptor of an article 3 received in the heating chamber 5 (for example of the type of heater 14 shown in FIG. 5). Alternatively, the device 1 may comprise plural heaters comprising a first heater arranged to heat the first major boundary surface 5a and a second heater arranged to heat the second major boundary surface 5b. In some embodiments the device 1 may comprise plural heaters, one heater being arranged to heat at least a portion of the surface of an article 3 received between the first and second major boundary surfaces 5a, 5b, and a second heater being arranged to heat an internal region of the article 3. Where there are plural heaters they may be configured to heat at different times and/or to different temperatures. In some embodiments, where the device 1 comprises a single heater 4 or plural heaters, it or they may be arranged or configured to heat only one of the first and second major boundary surfaces 5a, 5b.

The schematic drawings are not necessarily to scale and are presented for purposes of illustration and not limitation. The drawings depict one or more aspects described in this disclosure. However, it will be understood that other aspects not depicted in the drawings fall within the scope of this disclosure.

1.-13. (canceled)

14. A device for generating an aerosol, the device comprising:
a heating chamber configured to receive an article comprising an aerosol-forming substrate configured to form the aerosol, the heating chamber comprising an upstream end, a downstream end, and first and second major boundary surfaces, the first and the second major boundary surfaces extending in facing parallel relations and defining a principal flow axis for fluid flowing through the heating chamber;
a cooling chamber in fluid communication with the heating chamber and a mouthpiece end of the device; and
one or more induction coils configured to inductively heat the article, wherein the one or more induction coils each surround the heating chamber,
wherein the device is configured such that, in use, fluid flow from the upstream end of the heating chamber to the downstream end of the heating chamber is in a direction substantially parallel to the principal flow axis.

15. The device according to claim 14, wherein the device is further configured such that, in use, fluid flows through the upstream end of the heating chamber in the direction substantially parallel to the principal flow axis.

16. The device according to claim 14, wherein the first and the second major boundary surfaces are arranged to cause fluid exiting the heating chamber to flow in the direction substantially parallel to the principal flow axis.

17. The device according to claim 14, wherein the first major boundary surface is movable relative to the second major boundary surface into an open position or condition in which the article comprising the aerosol-forming substrate is insertable or removable from the heating chamber.

18. The device according to claim 17, wherein the first major boundary surface is slideable relative to the second major boundary surface into the open position or condition.

19. The device according to claim 17, wherein the first major boundary surface is pivotable relative to the second major boundary surface into the open position or condition.

20. The device according to claim 17, wherein the first major boundary surface is retained relative to the second major boundary surface in the open position or condition.

21. The device according to claim 14, comprising a heater configured to heat at least one of the first and the second major boundary surfaces.

22. The device according to claim 21, wherein the heater comprises at least one of a resistance heater and an induction heater.

23. The device according to claim 14, wherein, when the first and the second major boundary surfaces extend in facing parallel relations, the first and the second major boundary surfaces are spaced from one another by a distance of less than 5 mm.

24. A system for generating an aerosol, the system comprising the device of claim 14 and an article configured to form the aerosol, wherein the article comprises an aerosol-forming substrate and is configured to contact both the first and the second major boundary surfaces of the device when the article is received within the heating chamber.

25. A method of generating an aerosol, the method comprising:
providing a device configured to generate the aerosol, the device comprising
a heating chamber configured to receive an article for forming the aerosol, the heating chamber comprising an upstream end, a downstream end, and first and second major boundary surfaces extending in facing parallel relations,
a cooling chamber in fluid communication with the heating chamber and a mouthpiece end of the device, and
one or more induction coils configured to inductively heat the article, wherein the one or more induction coils each surround the heating chamber; and
causing a fluid to flow from the upstream end of the heating chamber to the downstream end of the heating chamber in a direction substantially parallel to a principal flow axis defined by the first and the second major boundary surfaces.

26. A method of generating an aerosol, the method comprising:
providing an article for forming the aerosol, the article comprising an aerosol-forming substrate;
providing a device configured to generate the aerosol, the device comprising
a heating chamber configured to receive the article for forming the aerosol, the heating chamber comprising first and second major boundary surfaces extending in facing parallel relations,
a cooling chamber in fluid communication with the heating chamber and a mouthpiece end of the device, and
one or more induction coils configured to inductively heat the article, wherein the one or more induction coils each surround the heating chamber; and
inserting the article into the heating chamber such that the article contacts both the first and the second major boundary surfaces.
